(19) United States
(12) Patent Application Publication
(10) Pub. No.: US 2026/0317226 A1
(43) Pub. Date: Oct. 15, 2026

(54) PACKAGING METHOD FOR VACUUM PLATE GLASS

(71) Applicant: Hebi Leadus Special Glass Manufacturing Co., Ltd., Hebi (CN)

(72) Inventors: Aotian SONG, Hebi (CN); Zichang GUO, Hebi (CN); Jinqing PENG, Hebi (CN)

(73) Assignee: Hebi Leadus Special Glass Manufacturing Co., Ltd., Hebi (CN)

(21) Appl. No.: 19/280,028

(22) Filed: Jul. 24, 2025

(30) Foreign Application Priority Data
Apr. 11, 2025 (CN) 202510459940.5

(51) Int. Cl. C03C 17/06; C03C 17/00; E06B 3/673

(52) U.S. Cl. CPC C03C 17/06; C03C 17/002; E06B 3/67334

(57) ABSTRACT

A packaging method for a vacuum plate glass includes following steps: acquisition of a flat shape of a target plate glass: collecting shape information of an edge side portion of target plate glass to obtain curve characteristics of the edge side portion of the target plate glass; coating of a surface metallization layer: coating, according to the curve characteristics of the edge side portion of the target plate glass, the edge side portion of the target plate glass with a continuous metallization layer; construction of surface support columns: arranging a plurality of support columns on a surface of the target plate glass; construction of a solder packaging layer: collecting position information of the metallization layer at the edge side portion of the target plate glass, and coating the metallization layer with a continuous solder packaging layer; and laminating and packaging.

### CROSS-REFERENCE TO RELATED APPLICATIONS

This application claims priority to Chinese Patent Application No. 202510459940.5, filed on Apr. 11, 2025, which is incorporated herein by reference in its entirety.

### TECHNICAL FIELD

The present disclosure relates to the technical field of glass manufacturing, and particularly provides a packaging method for a vacuum plate glass.

### BACKGROUND

With the deepening of the concept of building energy conservation and green environmental protection, vacuum glass has received widespread attention due to its excellent heat insulation and sound insulation performance. Generally, vacuum glass effectively reduces heat conduction and sound propagation by forming a vacuum layer between two pieces of glass, thereby improving the energy efficiency and living comfort of buildings.

However, the traditional packaging method for vacuum plate glass is often only applicable to standard rectangular vacuum glass. For vacuum glass with non-standard shapes such as round, oval, and triangular shapes, the packaging technology has certain limitations, which also limits the wide application of vacuum glass in architectural decoration and special application scenarios.

### SUMMARY

The purpose of the present disclosure is to provide a packaging method for a vacuum plate glass, aiming at solving the problem that the existing packaging methods for vacuum glass are difficult to adapt to the packaging requirements of non-standard shaped glass.

In order to achieve the above purpose, the technical solution adopted by the present disclosure is as follows.

Embodiments of the present disclosure provide a packaging method for a vacuum plate glass, including following steps:
acquisition of a flat shape of a target plate glass: collecting shape information of an edge side portion of target plate glass to obtain curve characteristics of the edge side portion of the target plate glass;
coating of a surface metallization layer: coating, according to the curve characteristics of the edge side portion of the target plate glass, the edge side portion of the plate glass with a continuous metallization layer;
construction of surface support columns: arranging a plurality of support columns on a surface of the target plate glass;
construction of a solder packaging layer: collecting position information of the metallization layer at the edge side portion of the target plate glass, and coating the metallization layer with a continuous solder packaging layer; and
laminating and packaging: laminating the target plate glass obtained after the above steps are completed, and packaging in a vacuum packaging furnace.

The present disclosure has the beneficial effects that the packaging method for the vacuum plate glass provided by the present disclosure adds the collection of the shape information of the edge side portion of the target plate glass for obtaining the corresponding curve characteristics, which provides parameter support for the subsequent coating of the surface metallization layer and the construction of the solder packaging layer, especially in the case where the target plate glass is non-standard shaped glass, with its edge side portion showing different curvatures; and accordingly, the coating of the metallization layer and the construction of the solder packaging layer can be used in more non-standard shaped target plate glass scenarios, thereby also meeting the packaging requirements of non-standard shaped target plate glass.

In some embodiments, the metallization layer has a thickness of 10-70 μm; and the metallization layer has a width of 1-15 mm.

In some embodiments, the solder packaging layer has a thickness of 20-150 μm; and the solder packaging layer has a width of 1-15 mm.

In some embodiments, in the step of acquiring the flat shape of the target plate glass, collecting an image of the edge side portion of the target plate glass to obtain the curve characteristics of the edge side portion of the target plate glass, the shape information of the edge side portion of the target plate glass is collected in real time using infrared scanning, and the curve characteristics of the edge side portion are recognized and obtained by an artificial intelligence device.

In some embodiments, in the step of constructing the solder packaging layer, collecting the position information of the metallization layer at the edge side portion of the target plate glass, and coating the metallization layer with the continuous solder packaging layer, the position information of the metallization layer is collected in real time using infrared scanning, and the curve characteristics of the edge side portion are recognized and obtained by the artificial intelligence device to achieve fine adjustment of the thickness and width of the solder packaging layer.

In some embodiments, prior to the step of acquisition of the flat shape of the target plate glass, collecting the shape information of the edge side portion of the target plate glass to obtain the curve characteristics of the edge side portion of the target plate glass, the packaging method further includes: cutting and polishing of the target plate glass: cutting the target plate glass into a predetermined shape, and polishing the edge side portion of the target plate glass.

In some embodiments, the packaging method further includes: placement of a getter: forming a groove structure in the surface of the target plate glass, and placing the getter in the groove structure.

In some embodiments, in the step of constructing the surface support columns, arranging the plurality of support columns on the surface of the target plate glass, a surface area of the target plate glass is obtained using infrared scanning, and placement point positions of all the support columns are constructed based on the artificial intelligence device according to the surface area of the target plate glass.

In some embodiments, between the step of constructing the surface support columns, arranging the plurality of support columns on the surface of the target plate glass and the step of constructing the solder packaging layer, collecting the position information of the metallization layer at the edge side portion of the target plate glass, and coating the metallization layer with the continuous solder packaging layer, the packaging method further includes:
tempering and sintering of the glass: tempering the target plate glass on which all the support columns are arranged in a glass tempering furnace, and sintering all the support columns to the target plate glass for connection.

In some embodiments, the packaging method further includes: activation and detection of the getter: heating the getter in the groove structure of the target plate glass to activate the getter, and carrying out a temperature difference experiment on the packaged target plate glass.

### BRIEF DESCRIPTION OF THE DRAWINGS

In order to more clearly illustrate the technical solutions in the embodiments of the present disclosure, a brief introduction will be given to the accompanying drawings required for the description of the embodiments or the prior art. Apparently, the accompanying drawings described below are merely some but not all of the embodiments of the present disclosure, and for those of ordinary skill in the art, without creative efforts, other drawings can also be obtained based on these drawings.

FIG. 1 is a flowchart of a packaging method for a vacuum plate glass provided in Embodiment I of the present disclosure.

FIG. 2 is a flowchart of a packaging method for a vacuum plate glass provided in Embodiment II of the present disclosure.

FIG. 3 is a flowchart of a packaging method for a vacuum plate glass provided in Embodiment III of the present disclosure.

FIG. 4 is a flowchart of a packaging method for a vacuum plate glass provided in Embodiment IV of the present disclosure.

FIG. 5 is a flowchart of a packaging method for a vacuum plate glass provided in Embodiment V of the present disclosure.

FIG. 6 is a top view of the vacuum plate glass provided in the embodiments of the present disclosure.

FIG. 7 is a cross-sectional view of the vacuum plate glass provided in the embodiments of the present disclosure in a laminated state.

### DETAILED DESCRIPTION OF THE EMBODIMENTS

Hereinafter, embodiments of the present disclosure will be described in detail, examples of which are illustrated in the accompanying drawings, where the same or similar reference numerals throughout denotes the same or similar components or components having the same or similar functions. The embodiments described below with reference to the accompanying drawings are exemplary and intended to explain the present disclosure, but not to be construed as limiting the present disclosure.

In the description of the present disclosure, it should be understood that the orientations or positional relationships indicated by the terms such as “length”, “width”, “upper”, “lower”, “front”, “back”, “left”, “right”, “vertical”, “horizontal”, “top”, “bottom”, “inner”, and “outer” are based on the orientations or positional relationships shown in the drawings, which are only for convenience in describing the present disclosure and simplifying the description, and do not indicate or imply that the devices or elements referred to must have particular orientations, or must be constructed and operated in particular orientations. Therefore, it cannot be construed as a limitation on the present disclosure.

In addition, the terms “first” and “second” are only used for descriptive purposes, and cannot be understood as indicating or implying their relative importance or implying the number of indicated technical features. Therefore, the features defined with “first” and “second” may explicitly or implicitly include one or more of these features. In the description of the present disclosure, “a plurality of” means two or more, unless otherwise specifically limited.

In the present disclosure, unless otherwise explicitly specified or defined, the terms such as “install”, “connect”, “connection”, and “fixation” should be understood in a broad sense. For example, the connection may be a fixed connection, a detachable connection, or an integral connection; or the connection may be a mechanical connection or an electrical connection; or the connection may be a direct connection, an indirect connection through an intermediary, or an internal communication or an interaction relationship between two components. Those of ordinary skill in the art could understand the specific meanings of the above terms in the present disclosure according to specific situations.

The traditional packaging method for vacuum plate glass is often only applicable to standard rectangular vacuum glass, because current packaging is difficult to achieve curved packaging. Therefore, for vacuum glass with non-standard shapes such as round, oval, and triangular shapes, the packaging technology has certain limitations.

For this reason, the present disclosure provides a packaging method for a vacuum plate glass, which adds collection of shape information of an edge side portion of target plate glass for obtaining corresponding curve characteristics, so as to provide parameter support for subsequent coating of a surface metallization layer and construction of a solder packaging layer, especially in the case where the target plate glass is non-standard shaped glass, with its edge side portion showing different curvatures; and accordingly, the coating of the metallization layer and the construction of the solder packaging layer can be used in more non-standard shaped target plate glass scenarios, thereby also meeting the packaging requirements of non-standard shaped target plate glass.

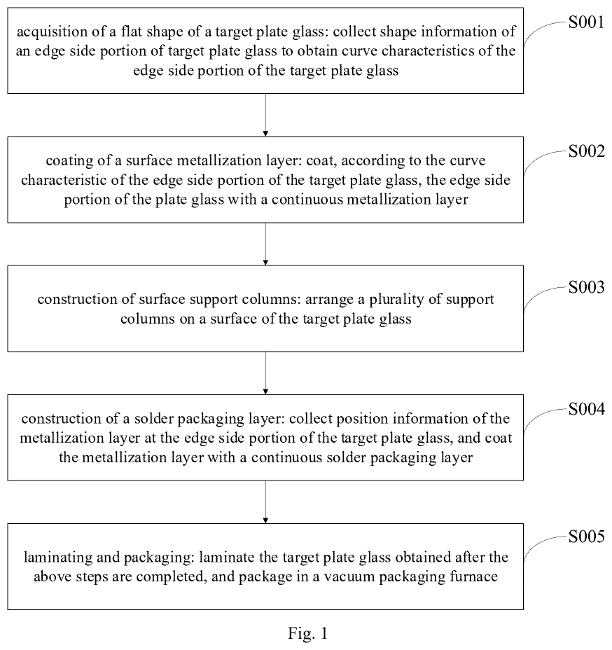

Referring to FIG. 1, an embodiment of the present disclosure provides a packaging method for a vacuum plate glass, including following steps:

S001, Acquisition of a flat shape of a target plate glass 100: collecting shape information of an edge side portion 101 of target plate glass 100 to obtain curve characteristics of the edge side portion 101 of the target plate glass 100.

Understandably, the flat shape of the target plate glass 100 refers to a shape presented by the current target plate glass 100 in a projection direction perpendicular to a surface of the target plate glass 100. For example, the flat shape of the target plate glass 100 may be a rectangle, a circle, an ellipse, a triangle, or other irregular shapes.

The edge side portion 101 of the target plate glass 100 refers to an edge position of the target plate glass 100, for example, an edge side portion of rectangular target plate glass is a straight edge side portion, and an edge side portion of circular or oval target plate glass is an arc-shaped edge side portion. That is, the edge side portion 101 may not be limited to being a straight side, an arc, a wave shape, or the like. Furthermore, the curve characteristic of the edge side portion 101 is a contour shape presented by the edge side portion 101 in the projection direction perpendicular to the surface of the target plate glass 100.

S002, Coating of a surface metallization layer 10: coating, according to the curve characteristics of the edge side portion 101 of the target plate glass 100, the edge side portion 101 of the target plate glass 100 with a continuous metallization layer 10.

Understandably, the metallization layer 10 refers to a metal coating with a certain thickness, which should have a first surface facing the edge side portion 101 of the target plate glass 100 and a second surface opposite to the first surface. The second surface should be a surface facing outward away from the edge side portion 101, and the second surface should also be a plane where a solder packaging layer is constructed in the subsequent process. Therefore, the first surface should be adapted to the edge side portion 101 of the target plate glass 100, then the first surface is complementary to the edge side portion 101, and the second surface should be a flat surface to meet the adhesion of the solder packaging layer in the subsequent process.

Here, the continuous metallization layer 10 means that on the edge side portion 101 of the target plate glass 100, the metal coating covers all of the edge side portion 101.

S003, Construction of surface support columns 102: arranging a plurality of support columns 102 on the surface of the target plate glass 100.

Understandably, the support columns 102 are columnar structures for supporting two pieces of target plate glass 100, that is, two opposite ends of each of the support columns 102 are respectively abutted against the two pieces of target plate glass 100. From this, it can be seen that the support columns 102 are located on the surface of the target plate glass 100, that is, the support columns 102 are located on the large surface of the target plate glass 100.

It should also be noted that the positions of all the support columns 102 on the surface of the target plate glass 100 may be adjusted according to actual usage needs. For example, the number and spacing of the support columns 102 may be set according to a surface area of the target plate glass 100.

S004, Construction of a solder packaging layer 20: collecting position information of the metallization layer 10 at the edge side portion 101 of the target plate glass 100, and coating the metallization layer 10 with a continuous solder packaging layer 20.

Understandably, before the target plate glass 100 is laminated and packaged, the solder packaging layer 20 needs to be disposed on the metallization layer 10, so that the target plate glass 100 is laminated through the solder packaging layer 20 to form closed vacuum glass.

S005, Laminating and packaging: laminating the target plate glass 100 obtained after the above steps are completed, and packaging in a vacuum packaging furnace.

Understandably, after the construction of the solder packaging layer 20 is completed, the target plate glass 100 is laminated with other components, and placed in the vacuum packaging furnace for final packaging treatment to ensure the airtightness of the vacuum glass during use and the stability of a vacuum layer.

The present disclosure provides the packaging method for the vacuum plate glass, which adds the collection of the shape information of the edge side portion 101 of the target plate glass 100 for obtaining the corresponding curve characteristics, so as to provide parameter support for the subsequent coating of the surface metallization layer 10 and the construction of the solder packaging layer 20, especially in the case where the target plate glass 100 is non-standard shaped glass, with its edge side portion 101 showing different curvatures; and accordingly, the coating of the metallization layer 10 and the construction of the solder packaging layer 20 can be used in more non-standard shaped target plate glass 100 scenarios, thereby also meeting the packaging requirements of non-standard shaped target plate glass 100.

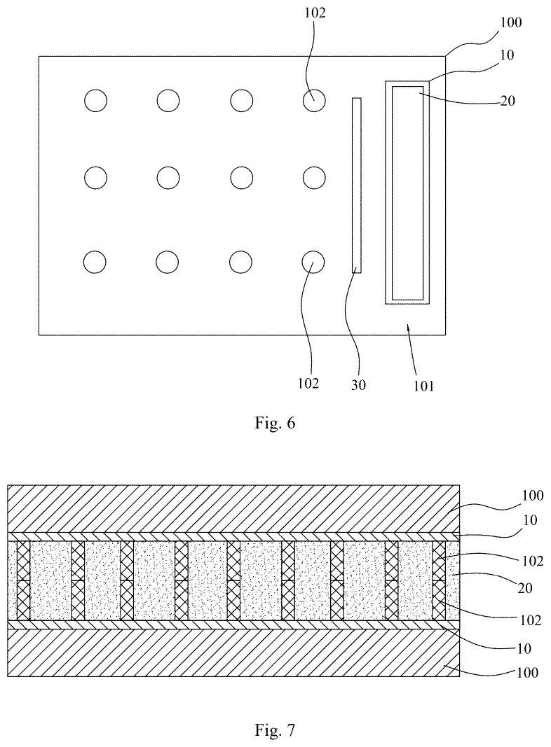

Referring to FIG. 6 and FIG. 7, in some embodiments, the metallization layer 10 has a thickness of 10-70 μm; and the metallization layer 10 has a width of 1-15 mm.

Understandably, the thickness of the metallization layer 10 may be an integer value such as 10μm, 20 μm, 30 μm, 40 μm, 50 μm, 60 μm, and 70 μm, or a decimal value such as 10.1 μm, 30.9 μm, and 60.05 μm.

The width of the metallization layer 10 may be an integer value such as 1 mm, 2 mm, 3 mm, 4 mm, 5 mm, 6 mm, 7 mm, 8 mm, 9 mm, 10 mm, 11 mm, 12 mm, 13 mm, 14 mm, and 15 mm, or a decimal value such as 1.1 mm, 7.159 mm, and 13.121 mm.

Referring to FIG. 6 and FIG. 7, in some embodiments, the solder packaging layer 20 has a thickness of 20-150 μm; and the solder packaging layer 20 has a width of 1-15 mm.

Understandably, the thickness of the solder packaging layer 20 may be an integer value such as 20 μm, 30 μm, 40 μm, 50 μm, 60 μm, 70 μm, 80 μm, 90 μm, 100 μm, 110 μm, 120 μm, 130 μm, 140 μm, and 150 μm, or a decimal value such as 10.1 μm, 30.9 μm, 60.05 μm, 100.36 μm, and 149.36 μm.

The width of the solder packaging layer 20 may be an integer value such as 1 mm, 2 mm, 3 mm, 4 mm, 5 mm, 6 mm, 7 mm, 8 mm, 9 mm, 10 mm, 11 mm, 12 mm, 13 mm, 14 mm, and 15 mm, or a decimal value such as 1.1 mm, 7.159 mm, and 13.121 mm.

In some embodiments, in the step of acquiring the flat shape of the target plate glass 100, collecting an image of the edge side portion 101 of the target plate glass 100 to obtain the curve characteristics of the edge side portion 101 of the target plate glass 100, the shape information of the edge side portion 101 of the target plate glass 100 is collected in real time using infrared scanning, and the curve characteristics of the edge side portion 101 are recognized and obtained by an artificial intelligence device.

Understandably, infrared scanning technology is a non-contact detection and imaging technology based on infrared radiation characteristics of objects, which is widely used in industrial detection, security monitoring, medical diagnosis, military reconnaissance and other fields. It may usually be implemented by an infrared scanning system. The infrared scanning system generally includes an optical system, a detector, a signal processing system and a display system. In this way, formation information of the edge side portion 101 of the target plate glass 100 may be obtained by the technical means of infrared scanning.

The artificial intelligence device may include an edge detection operator device, an edge detection network device, a wheel width extraction and shape analysis device, and the like, where the edge detection operator device may include a Canny edge detection device, a Prewitt operator device and a Laplacian operator device; the Canny edge detection device is a classic edge detection algorithm, which can extract continuous edge curves through Gaussian filtering, gradient calculation, non-maximum suppression and double-threshold processing; the Prewitt operator device is based on first-order gradient calculation and thus is suitable for fast edge detection; and the Laplacian operator device is based on second-order derivatives, sensitive to noise, but able to detect more subtle edge changes. The edge detection network device may include an edge convolutional network and holistically-nested edge detection (HED), where the edge convolutional network may be used for, as mentioned in an automatic driving-oriented edge feature extraction method, effectively identifying edge features in an image by constructing a spatial relationship model through three convolutional templates of a star type, a fishing net type and a cross type.

In this way, the curve characteristics, such as a curvature and a slope, of the edge side portion 101 of the target plate glass 100 may be ultimately obtained to prepare for the coating of the metallization layer 10 in the subsequent process.

In some embodiments, in the step of constructing the solder packaging layer 20, collecting the position information of the metallization layer 10 at the edge side portion 101 of the target plate glass 100, and coating the metallization layer 10 with the continuous solder packaging layer 20, the position information of the metallization layer 10 is collected in real time using infrared scanning, and the curve characteristics of the edge side portion 101 are recognized and obtained by the artificial intelligence device to achieve fine adjustment of the thickness and width of the solder packaging layer 20.

Similarly, the same infrared scanning technology and artificial intelligence device can be used to obtain the position information of the metallization layer 10, providing data support for the coating of the solder packaging layer 20.

For example, there are differences in color difference and light transmittance between the metallization layer 10 and the edge side portion 101 of the target plate glass 100. Therefore, this may be used as a basis to distinguish the metallization layer 10 from the edge side portion 101 of the target plate glass 100.

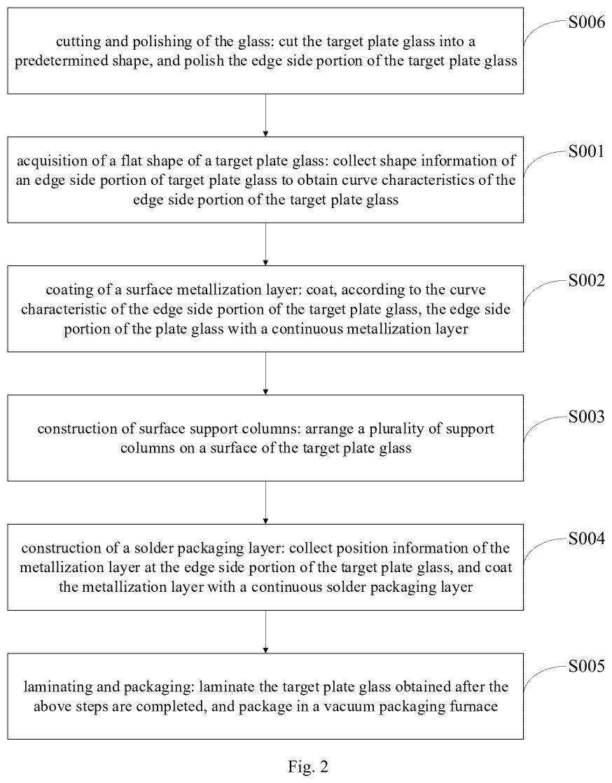

Referring to FIG. 2, in some embodiments, prior to the step of acquisition of the flat shape of the target plate glass 100, collecting the shape information of the edge side portion 101 of the target plate glass 100 to obtain the curve characteristics of the edge side portion 101 of the target plate glass 100, the packaging method further includes:

S006, cutting and polishing of the glass: cutting the target plate glass 100 into a predetermined shape, and polishing the edge side portion 101 of the target plate glass 100.

Understandably, according to actual usage needs, the target plate glass 100 is cut into a corresponding shape, such as elliptical plate glass, circular plate glass, and triangular plate glass. After cutting, an automated polishing machine may be used for polishing an edge portion of the target plate glass 100, which eliminates burrs and irregular shapes generated during the cutting process, thus providing a foundation for the coating of the metallization layer 10 and the construction of the solder packaging layer 20 in the subsequent processes.

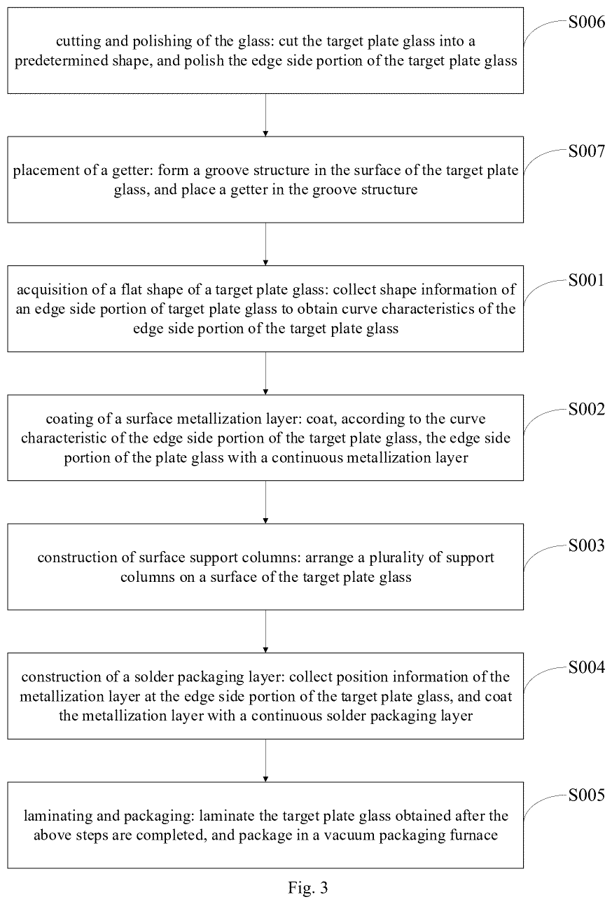

Referring to FIG. 3 and FIG. 6, in some embodiments, the packaging method further includes:

S007, placement of a getter 30: forming a groove structure in the surface of the target plate glass 100, and placing the getter 30 in the groove structure.

Understandably, the function of the getter 30 is to suck the residual gas and water vapor in the vacuum glass, and further improve the vacuum degree of the vacuum glass after lamination. Therefore, the getter 30 needs to be placed on the target plate glass 100 before lamination.

A placement method of the getter 30 includes: forming the groove structure in the surface of the target plate glass 100, where the groove structure may be circular or square, and storing the getter 30 inside the groove structure.

In some embodiments, in the step of constructing the surface support columns 102, arranging the plurality of support columns 102 on the surface of the target plate glass 100, a surface area of the target plate glass 100 is obtained using infrared scanning, and placement point positions of all the support columns 102 are constructed based on the artificial intelligence device according to the surface area of the target plate glass 100.

For example, in the case where the target plate glass 100 is round glass, infrared scanning technology is used to calculate the surface area of the round glass, and construct the placement point positions of all the support columns 102 based on the artificial intelligence device according to the surface area of the round glass.

Alternatively, for example, in the case where the target plate glass 100 is triangular glass, infrared scanning technology is used to calculate the surface area of the triangular glass, and construct the placement point positions of all the support columns 102 based on the artificial intelligence device according to the surface area of the triangular glass.

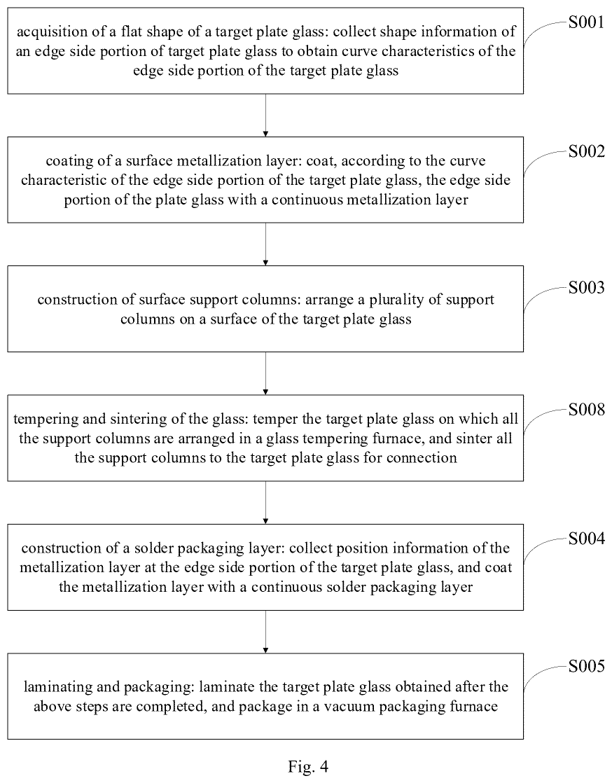

Referring to FIG. 4, in some embodiments, between the step of constructing the surface support columns 102, arranging the plurality of support columns 102 on the surface of the target plate glass 100 and the step of constructing the solder packaging layer 20, collecting the position information of the metallization layer 10 at the edge side portion 101 of the target plate glass 100, and coating the metallization layer 10 with the continuous solder packaging layer 20, the packaging method further includes:

S008, tempering and sintering of the glass: tempering the target plate glass 100 on which all the support columns 102 are arranged in a glass tempering furnace, and sintering all the support columns 102 to the target plate glass 100 for connection.

Understandably, the target plate glass 100 is tempered in the glass tempering furnace to improve its compressive strength and high temperature resistance, thus ensuring its stability and reliability in subsequent use. Furthermore, the metallization layer 10 and the support columns 102 can be quickly sintered on the surface of the target plate glass 100 at the current temperature to provide a higher bonding force.

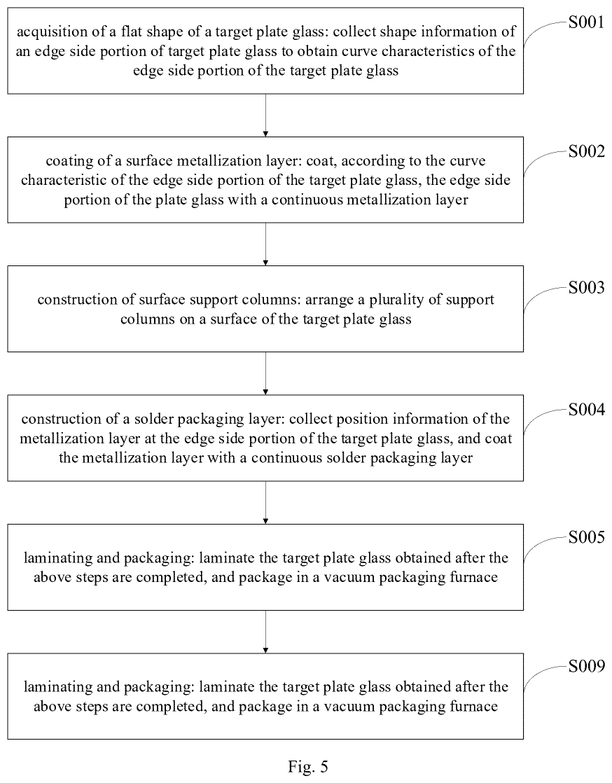

Referring to FIG. 5, in some embodiments, the packaging method further includes:

S009, activation and detection of the getter 30: heating the getter 30 in the groove structure of the target plate glass 100 to activate the getter 30, and carrying out a temperature difference experiment on the packaged target plate glass 100.

Understandably, after the packaging process is completed, an electromagnetic induction device is used to locally heat and activate the getter 30 to suck the residual gas and water vapor in the vacuum glass and further improve the vacuum degree inside the vacuum glass; and in addition, the vacuum performance of the vacuum glass is tested by the temperature difference experiment.

The following will be illustrated by specific embodiments.

### Embodiment 1

Cutting and polishing of glass: A piece of oval target plate glass 100 is selected for use, with the oval shape being ensured to meet the specification requirements. The target plate glass 100 is cut, and then an edge of the glass is polished using an automated polishing machine to eliminate burrs and irregular shapes generated during the cutting process, thus providing a foundation for metallization coating and construction of a packaging layer in the subsequent processes.

Placement of a getter 30: According to the design requirements, high-precision laser drilling equipment is used to create a circular or square groove in a surface of the target plate glass 100 to ensure the accuracy and consistency of a hole position of a getter 30, providing support for the subsequent suction of residual gas from an interior of the glass.

Acquisition of a flat shape of the target plate glass 100: Shape information of an edge side portion 101 of the target plate glass 100 is collected to obtain curve characteristics of the edge side portion 101 of the target plate glass 100.

Coating of a surface metallization layer 10: The edge side portion 101 of the target plate glass 100 is metallized using metallization dispensing and spraying equipment. In the process of metallization, an edge shape of the oval glass is collected in real time by an infrared scanning system, and an artificial intelligence device recognizes the curve characteristics of the edge side portion 101 of the target plate glass 100 to ensure that the metallization coating evenly covers the entire edge side portion 101 of the target plate glass 100. By dynamically adjusting working parameters of the spraying equipment, a thickness of the metallization layer 10 is controlled at 40 μm, a width thereof is controlled at 8 mm, and an error is controlled within ±5 μm.

Construction of surface support columns 102: According to the design requirements, a lattice array with a size of 50*50 mm is arranged on the surface of the target plate glass 100, and ceramic dispensing and spraying equipment is used for point distribution treatment. In the process of distributing support columns 102, the infrared scanning system is used to collect the shape, size and range of the oval target plate glass 100 in real time, and the artificial intelligence device automatically constructs distribution points of the support columns 102 to ensure that a lattice formed by the support columns 102 is uniform within the surface of the entire oval target plate glass 100. By dynamically adjusting working parameters of point distribution equipment, thicknesses of the support columns 102 are controlled at 40 μm, diameters thereof are controlled at 0.5 mm, and an error is controlled within ±5 μm.

Tempering and sintering of the glass: The oval target plate glass 100 is tempered in a glass tempering furnace to improve its compressive strength and high temperature resistance, thus ensuring its stability and reliability in subsequent use. Furthermore, the metallization layer 10 and the support columns 102 can be quickly sintered on the surface of the glass at the current temperature to provide a higher bonding force.

Construction of a solder packaging layer 20: Automated soldering equipment is adopted to uniformly coat the metallization layer 10 with a solder packaging layer 20. During this process, the metallization layer 10 on the edge side portion 101 of the oval target plate glass 100 is collected in real time using the infrared scanning system. The artificial intelligence device recognizes the edge curve characteristics to ensure that the thickness and width of the solder packaging layer 20 are fine-adjusted through a real-time feedback control system during the soldering process, thus ensuring the uniformity and integrity of the solder packaging layer 20. A thickness of the solder packaging layer 20 is controlled at 80μm, a width thereof is controlled at 12 mm, and an error is controlled within ±10 μm.

Laminating and packaging: After the construction of the packaging layer is completed, the processed oval target plate glass 100 is laminated with other components and put into a vacuum packaging furnace for final packaging treatment, which ensures the airtightness of the glass during use and the stability of a vacuum layer.

Activation and detection of the getter 30: after the packaging process is completed, an electromagnetic induction device is used to locally heat and activate the getter 30 to suck the residual gas and water vapor in the vacuum glass and further improve the vacuum degree inside the vacuum glass; and in addition, the vacuum performance of the vacuum glass is tested by a temperature difference experiment.

### Embodiment 2

Cutting and polishing of glass: A piece of triangular target plate glass 100 is selected for use, with the triangular shape being ensured to meet the specification requirements. The target plate glass 100 is cut, and then an edge of the glass is polished using an automated polishing machine to eliminate burrs and irregular shapes generated during the cutting process, thus providing a foundation for metallization coating and construction of a packaging layer in the subsequent processes.

Placement of a getter 30: According to the design requirements, high-precision laser drilling equipment is used to create a circular or square groove in a surface of the target plate glass 100 to ensure the accuracy and consistency of a hole position of a getter 30, providing support for the subsequent suction of residual gas from an interior of the glass.

Acquisition of a flat shape of the target plate glass 100: Shape information of an edge side portion 101 of the target plate glass 100 is collected to obtain curve characteristics of the edge side portion 101 of the target plate glass 100.

Coating of a surface metallization layer 10: The edge side portion 101 of the target plate glass 100 is metallized using metallization dispensing and spraying equipment. In the process of metallization, an edge shape of the triangular glass is collected in real time by an infrared scanning system, and an artificial intelligence device recognizes the curve characteristics of the edge side portion 101 of the target plate glass 100 to ensure that the metallization coating evenly covers the entire edge side portion 101 of the target plate glass 100. By dynamically adjusting working parameters of the spraying equipment, a thickness of the metallization layer 10 is controlled at 40 μm, a width thereof is controlled at 8 mm, and an error is controlled within ±5 μm.

Construction of surface support columns 102: According to the design requirements, a lattice array with a size of 50*50 mm is arranged on the surface of the target plate glass 100, and ceramic dispensing and spraying equipment is used for point distribution treatment. In the process of distributing support columns 102, the infrared scanning system is used to collect the shape, size and range of the triangular target plate glass 100 in real time, and the artificial intelligence device automatically constructs distribution points of the support columns 102 to ensure that a lattice formed by the support columns 102 is uniform within the surface of the entire triangular target plate glass 100. By dynamically adjusting working parameters of point distribution equipment, thicknesses of the support columns 102 are controlled at 40 μm, diameters thereof are controlled at 0.5 mm, and an error is controlled within ±5 μm.

Tempering and sintering of the glass: The triangular target plate glass 100 is tempered in a glass tempering furnace to improve its compressive strength and high temperature resistance, thus ensuring its stability and reliability in subsequent use. Furthermore, the metallization layer 10 and the support columns 102 can be quickly sintered on the surface of the glass at the current temperature to provide a higher bonding force.

Construction of a solder packaging layer 20: Automated soldering equipment is adopted to uniformly coat the metallization layer 10 with a solder packaging layer 20. During this process, the metallization layer 10 on the edge side portion 101 of the triangular target plate glass 100 is collected in real time using the infrared scanning system. The artificial intelligence device recognizes the edge curve characteristics to ensure that the thickness and width of the solder packaging layer 20 are fine-adjusted through a real-time feedback control system during the soldering process, thus ensuring the uniformity and integrity of the solder packaging layer 20. A thickness of the solder packaging layer 20 is controlled at 80 μm, a width thereof is controlled at 12 mm, and an error is controlled within ±10 μm.

Laminating and packaging: After the construction of the packaging layer is completed, the processed triangular target plate glass 100 is laminated with other components and put into a vacuum packaging furnace for final packaging treatment, which ensures the airtightness of the glass during use and the stability of a vacuum layer.

Activation and detection of the getter 30: after the packaging process is completed, an electromagnetic induction device is used to locally heat and activate the getter 30 to suck the residual gas and water vapor in the vacuum glass and further improve the vacuum degree inside the vacuum glass; and in addition, the vacuum performance of the vacuum glass is tested by a temperature difference experiment.

The foregoing descriptions are merely exemplary embodiments of the present disclosure, and are not intended to limit the present disclosure. Any modification, equivalent replacement and improvement made within the spirit and principle of the present disclosure should be included in the protection scope of the present disclosure.

What is claimed is:

1. A packaging method for a vacuum plate glass, comprising following steps:
acquisition of a flat shape of a target plate glass: collecting shape information of an edge side portion of the target plate glass to obtain curve characteristics of the edge side portion of the target plate glass;
coating of a surface metallization layer: coating, according to the curve characteristics of the edge side portion of the target plate glass, the edge side portion of the plate glass with a continuous metallization layer;
construction of surface support columns: arranging a plurality of support columns on a surface of the target plate glass;
construction of a solder packaging layer: collecting position information of the metallization layer at the edge side portion of the target plate glass, and coating the metallization layer with a continuous solder packaging layer; and
laminating and packaging: laminating the target plate glass obtained after the above steps are completed, and packaging in a vacuum packaging furnace.

2. The packaging method for the vacuum plate glass according to claim 1, wherein the metallization layer has a thickness of 10-70 μm; and the metallization layer has a width of 1-15 mm.

3. The packaging method for the vacuum plate glass according to claim 1, wherein the solder packaging layer has a thickness of 20-150 μm; and the solder packaging layer has a width of 1-15 mm.

4. The packaging method for the vacuum plate glass according to claim 1, wherein in the step of acquiring the flat shape of the target plate glass, collecting an image of the edge side portion of the target plate glass to obtain the curve characteristics of the edge side portion of the target plate glass, the shape information of the edge side portion of the target plate glass is collected in real time using infrared scanning, and the curve characteristics of the edge side portion are recognized and obtained by an artificial intelligence device.

5. The packaging method for the vacuum plate glass according to claim 1, wherein in the step of constructing the solder packaging layer, collecting the position information of the metallization layer at the edge side portion of the target plate glass, and coating the metallization layer with the continuous solder packaging layer, the position information of the metallization layer is collected in real time using infrared scanning, and the curve characteristics of the edge side portion are recognized and obtained by the artificial intelligence device to achieve fine adjustment of the thickness and width of the solder packaging layer.

6. The packaging method for the vacuum plate glass according to claim 1, wherein prior to the step of acquisition of the flat shape of the target plate glass, collecting the shape information of the edge side portion of the target plate glass to obtain the curve characteristics of the edge side portion of the target plate glass, the packaging method further comprises:
cutting and polishing of the target plate glass: cutting the plate glass into a predetermined shape, and polishing the edge side portion of the target plate glass.

7. The packaging method for the vacuum plate glass according to claim 6, further comprising:
placement of a getter: forming a groove structure in the surface of the target plate glass, and placing the getter in the groove structure.

8. The packaging method for the vacuum plate glass according to claim 1, wherein in the step of constructing the surface support columns, arranging the plurality of support columns on the surface of the target plate glass, a surface area of the target plate glass is obtained using infrared scanning, and placement point positions of all the support columns are constructed based on the artificial intelligence device according to the surface area of the target plate glass.

9. The packaging method for the vacuum plate glass according to claim 8, wherein between the step of constructing the surface support columns, arranging the plurality of support columns on the surface of the target plate glass and the step of constructing the solder packaging layer, collecting the position information of the metallization layer at the edge side portion of the target plate glass, and coating the metallization layer with the continuous solder packaging layer, the packaging method further comprises:
tempering and sintering of the glass: tempering the target plate glass on which all the support columns are arranged in a glass tempering furnace, and sintering all the support columns to the target plate glass for connection.

10. The packaging method for the vacuum plate glass according to claim 7, further comprising:
activation and detection of the getter: heating the getter in the groove structure of the target plate glass to activate the getter, and carrying out a temperature difference experiment on the packaged target plate glass.
